(19) United States
(12) Patent Application Publication
(10) Pub. No.: US 2004/0057408 A1
(43) Pub. Date: Mar. 25, 2004

(54) Method and system of providing bandwidth on demand to WAN user from WLAN access point

(76) Inventor: William H. Gray, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/246,957

(22) Filed: Sep. 19, 2002

(51) Int. Cl. H04Q 7/24

(52) U.S. Cl. 370/338; 370/349

(57) ABSTRACT

A system and method of providing bandwidth on demand to a Wide Area Network (WAN) user from a Wireless Local Area Network (WLAN) access point including determining a current position of a mobile appliance associated with the WAN user by a mobile switching center; transmitting the current position of the mobile appliance to a position location server over a WAN network; selecting a WLAN access point position location server that is accessible from the current position of the mobile appliance; determining the direction to the mobile appliance from the serving access point transmitting the direction to the serving access point; controlling a serving access point directional antenna so that it points in the direction of the mobile appliance; and establishing a communication link with the mobile appliance to provide bandwidth on a WLAN network to the WAN user, thereby enabling the WAN user to access and utilize a WLAN network for performing a task.

### CROSS-REFERENCE TO RELATED APPLICATIONS

This application is related to co-pending patent application entitled “Method and System of Informing WAN User of Nearby WLAN Access Points,” Ser. No. ______ [attorney docket number 10111008-1], filed concurrently herewith, the disclosure of which is incorporated herein in its entirety.

### FIELD OF THE INVENTION

The present invention relates generally to communications systems and, in particular, to a method and system of providing bandwidth on demand to Wide Area Network (WAN) users from Wireless Local Area Network (WLAN) access points.

### BACKGROUND OF THE INVENTION

A WAN cellular communications or wireless telecommunications network system includes a number of fixed base stations (also known as cell sites) interconnected by a cable medium to a Mobile Switching Center (MSC) that connects to the Public Switched Telephone Network (PSTN). The PSTN is often referred to as the system backbone.

Associated with each base station is a geographic cell. The cell is a geographic coverage area in which a base station has sufficient signal strength to transmit data and receive data from mobile appliances, such as a data terminal, personal digital assistant (PDA), pager or telephone, with an acceptable error rate. Typically, base stations are positioned such that the combined cell area coverage from each base station provides full coverage of a particular area or zone.

Mobile appliances, such as telephone, pagers, PDAs, email devices, data terminals and the like, are designed to be moved throughout the system from cell to cell. Each mobile appliance is capable of communicating with the system backbone via wireless communications between the device and a base station to which the mobile appliance is registered. As the wireless subscriber roams from one cell to another, the mobile appliance associated with a wireless subscriber will typically deregister with the base station of the previous cell and register with the base station associated with the new cell.

WANs can be co-located with other telecommunication networks, such as wireless local area networks. Local Area Networks (LANs) are typically connected by routers and bridges, and typically connect their mobile appliances, such as notebook computers or PDAs, via a wireless 802.11 access point. Routers and bridges differ in that routers operate at the network layer level of the International Standards Organization (ISO) Open Systems Interconnection (OSI) reference model, and bridges operate at the data link layer of the OSI reference model. Currently available IEEE 802.11 access points utilize the 802.11b (11 Mbps data rate) or IEEE 802.11a (54 Mbps data rate) standards. For geographically dispersed WLANs, the WLANs can be interconnected by use of the PSTN, Public Switched Data Network (PSDN), Integrated Services Digital Network (ISDN), the Internet and the like.

Although the generally available data transmission rates of the WAN are adequate to support many current wireless voice and data services, such as email, cellular calls and the like, it is not suitable for transmitting, receiving, uploading or downloading a video file or other large data file, such as an attachment to an email. A typical WAN cell site covers a few kilometers while a typical IEEE 802.11b WLAN access point covers about 100 meters. Therefore, a user may be within range of a WAN base station yet out of range of the higher data rate WLAN access point. Additionally, the WAN user connected to a WAN network is generally unaware of and/or can't locate nearby access points to access and utilize a high bandwidth transmission system, such as a WLAN-based network.

Accordingly, the present invention proceeds upon the desirability of providing WLAN network bandwidth on demand to WAN users from WLAN access points or sites, thereby enabling the WAN user to access and utilize the desired WLAN bandwidth from a high speed WLAN-based network to efficiently and quickly transmit, receive, upload or download a video file or a large data file.

### BRIEF SUMMARY OF THE INVENTION

A method of providing bandwidth on demand to a WAN user from a WLAN access point determines a current position of a mobile appliance associated with the WAN user by a mobile switching center. The current position of the mobile appliance is transmitted to a position location server over a WAN network. The position location server selects a serving access point that is accessible from and nearest to the current position of the mobile appliance. The position location server also determines the direction to the mobile appliance from the serving access point and transmits the direction to the serving access point. The serving access point controls its directional antenna so that it points in the direction of the mobile appliance and establishes a communication link with the mobile appliance to provide bandwidth on a WLAN network to the WAN user. This enables the WAN user to access and utilize a WLAN network for performing a task.

A system for providing bandwidth on demand to a WAN user from a WLAN access point comprising a WAN network having a plurality of cell sites and a WLAN network having a plurality of WLAN access points. Each WLAN access point includes at least one directional antenna. The system also includes a mobile appliance associated with the WAN user and in communication with a serving cell site. The serving cell site being one of said plurality of cell sites and the mobile switching center, connected to the WAN network, for determining a current position of the mobile appliance. The system further comprises at least one position location server, connected to the WAN network and the WLAN network, for receiving the current position of the mobile appliance from the mobile switching center over the WAN network, and selecting a WLAN access point that is accessible from and nearest to the current position of the mobile appliance to provide a serving WLAN access point. The serving WLAN access point establishes a communication link with the mobile appliance and provides a bandwidth on the WLAN network to the WAN user. This enables the WAN user to access and utilize the WLAN network for performing a task.

### BRIEF DESCRIPTION OF THE DRAWINGS

For a more complete understanding of the present invention, reference is now made to the following descriptions taken in conjunction with the accompanying drawings, in which:

FIG. 1 illustrates an example of wireless telecommunications network system incorporating a WAN;

FIG. 2 illustrates an example of wireless telecommunications network system incorporating a WLAN;

FIG. 3 illustrates an exemplary process of registering a cell phone to a mobile switching center;

FIG. 4 illustrates an exemplary process of delivering calls to a WAN user roaming in the cellular communications system;

FIG. 5 illustrates a method of providing WLAN bandwidth on demand to a WAN user from a WLAN cell site in accordance with an embodiment of the present invention; and

FIG. 6 is a schematic representation of WLAN enabled mobile appliance in accordance with an aspect of the present invention.

### DETAILED DESCRIPTION OF THE INVENTION

Wireless Local Area Networks have been developed and are now used in offices, retail stores and large industrial facilities. WLANs provide data communication between computers, printers, servers and other devices without the trouble and expense of installing wires and cables. In addition to data communication, WLANs can provide voice communication between appliances on the WLAN.

The IEEE 802.11 standard is a standard for WLANs and represents a family of specifications developed for systems that operate in the 2.4 GHz Industrial, Scientific and Medical (ISM) band and the 5.0 GHz Unlicensed National Information Infrastructure (U-NII) band. The ISM band is available worldwide and allows unlicensed operation of spread spectrum systems. Portions of the 5.0 GHz UNII band are available worldwide with various country-specific regulatory limitations. The IEEE 802.11 RF transmissions use multiple signaling schemes (modulations) at different data rates to deliver a single data packet between wireless systems. The IEEE 802.11 wireless LAN uses a band of frequencies near 2.4 Ghz to support data communication at up to 11 Mbps using Direct Sequence Spread Spectrum (DSSS) modulation. The 802.11a wireless LAN uses frequencies near 5.0 GHz to support data communication at rates up to 54 Mbps using Orthogonal Frequency Division Multiplexing (OFDM).

Turning now to FIG. 1, cellular communications or wireless telecommunications network system 10 comprises WAN or network backbone 12, which can be a hardwired data communication path made of twisted pair cable, shielded coaxial cable or fiber optic cable, for example, or may be wireless or partially wireless in nature. Coupled to WAN 12 is one or more fixed communication devices 17 and several access or cell sites 14. Although two access or cell sites 14 are shown hardwired to network backbone 12, it will be understood by those of skill in the art that one or several cell sites 14 can be coupled to network backbone 12 via a wired or wireless connection.

Each cell site 14 is capable of communicating wirelessly with mobile appliances 18, such as cell phones, pagers, Personal Digital Assistants (PDAs), email devices (e.g., BLACKBERRY™) and the like, in wireless communication system 10 via respective antennas commonly denoted by reference numeral 16. A geographic cell (not shown) associated with each cell site 14 defines a region of coverage in which successful wireless communication may occur. Depending on the type of antenna 16 selected and output power of the respective cell site 14, the geographic cell may take one of several different forms and sizes as is know in the art.

Mobile appliances 18, each include antenna 19 for wirelessly communicating with other mobile appliances 18. It is appreciated that the antenna 19 may be comprised of multiple antennas tuned for the respective operating frequencies. Each mobile appliance 18 can communicate with fixed communication devices 17 (such as telephone or computer connected to the PSTN or PSDN, an Internet server, etc.) and/or other mobile appliances 18 on network backbone 12 via selected cell site 14. Upon roaming from one cell to another, mobile appliances 18 are configured to associate with a new cell site 14. Mobile appliance 18 registers with a particular cell site 14 to obtain wireless access to network backbone 12. Typically cell sites 14 and mobile appliances 18 in different cells can communicate with each other during the same time period, such that simultaneous communication is occurring in wireless system 10.

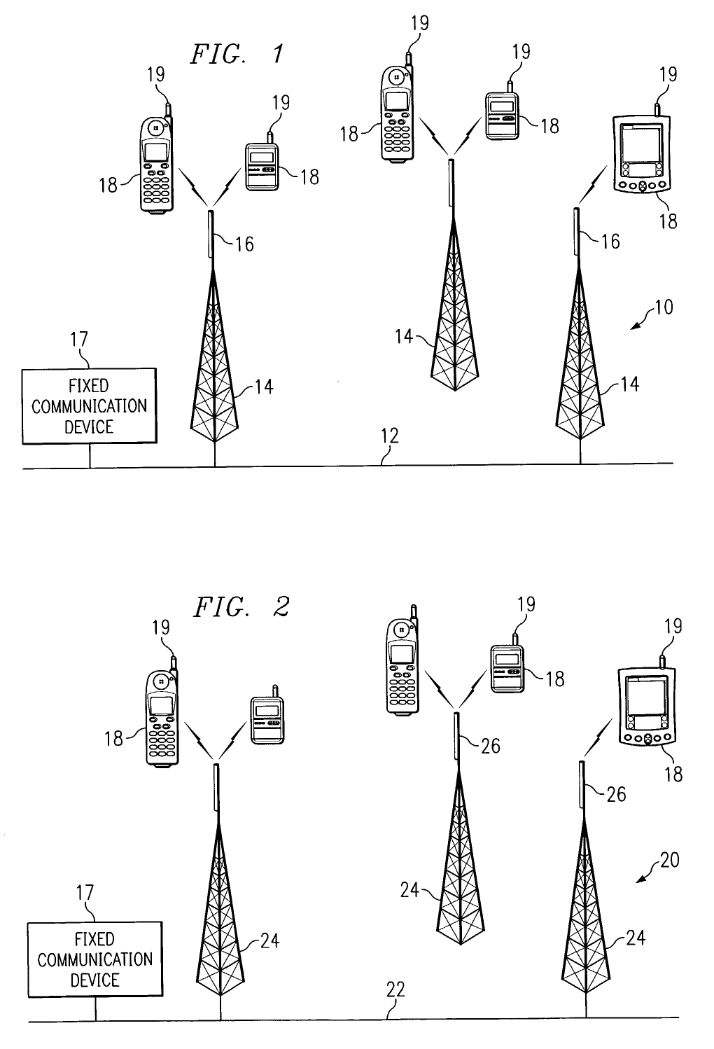

Turning now to FIG. 2, wireless telecommunications network system 20 comprises WLAN 22. WLAN 22 can be a hardwired data communication path made of twisted pair cable, shielded coaxial cable or fiber optic cable, for example, or may be wireless or partially wireless in nature. Coupled to WLAN 22 are one or more fixed communication devices 17 and several WLAN access points 24. Although only two WLAN access points 24 are shown hardwired to WLAN 22, several WLAN access points 24 can be coupled to WLAN 22 via a wired or wireless connection.

Each WLAN access point 24 is capable of communicating wirelessly with mobile appliances 18, such as cell phones, pagers, PDAs, email devices (e.g., BLACKBERRY™), etc., in wireless communication system 20 via respective antennas commonly denoted by reference numeral 26. Antenna 26 associated with each WLAN access point 24 is a steerable (either mechanically or electrically) directional antenna that can be directed to a particular position or direction, thereby facilitating uni-directional or bi-directional data transmission to a particular mobile appliance 18. A geographic cell (not shown) associated with each WLAN access point 24 defines a region of coverage in which successful wireless communication may occur. Depending on the type of directional antenna 26 selected and output power of the respective WLAN access point 24, the geographic cell may take one of several different forms and sizes.

Wireless system 20 also includes one or more mobile appliances 18. Each mobile appliance 18 communicates with fixed communication devices 17 (such as telephone or computer connected to the PSTN or PSDN, an Internet server, etc.) and/or other mobile appliances 18 on WLAN 22 via selected WLAN access point 24. Preferably, WLAN 22 conforms to the IEEE standard 802.11b “Direct Sequence Spread Spectrum (DSSS) Physical Layer Specification”. Alternatively, WLAN 22 can employ the IEEE standard 802.11 “Frequency Hopping Spread Spectrum (FHSS) Physical Layer Specification” or IEEE standard 802.11a “Orthogonal Frequency Division Multiplexing Physical Layer Specification”.

In accordance with an embodiment of the present invention, mobile appliance 18 includes circuitry and/or software to communicate over both WAN based network 10 and WLAN based network 20. WAN based network 10 can be any type of cellular/wireless network, including but not limited to Global System for Mobile Communications (GSM) network, Code Division Multiple Access (CDMA) networks, Time Division Multiple Access (TDMA) network, Personal Communication Services (PCS) network, Wide-Band (WCDMA) networks 3G networks, etc. It is appreciated that any mobile appliance or wireless communications device, including but not limited to a cell phone, data terminal, PDA, pager, and email device (e.g., BLACKBERRY™), can be used to practice the present invention.

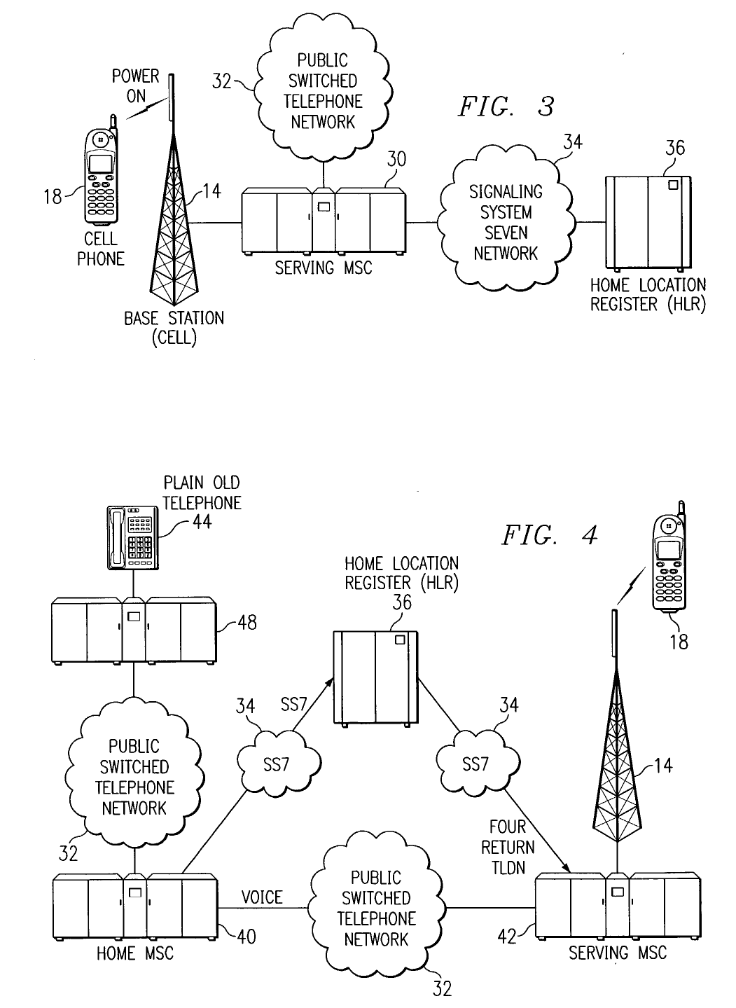

Turning now to FIG. 3, there is illustrated an aspect of the present invention wherein WLAN-enabled mobile appliance 18 is a cell phone. Cell phone 18 operates as a normal cellular phone over WAN based cellular network 10 in FIG. 1. When cell phone 18 is turned on, it sends a data message to the nearest cell site or base station 14. The message generally contains the Mobile Identification Number (MIN) and the Electronic Serial Number (ESN). Cell site 14 forwards the MIN and ESN information to a switch or Mobile Switching Center (MSC) 30, which is generally referred to as the serving mobile switching center. MSC 30 is connected to a WAN-based cellular network that can comprise PSTN 32 and Signaling System Seven (SS7) network 34. Mobile switching center 30 compares the MIN with a table of all MINs in the WAN-based cellular network and determines which database contains the WAN or cellular user's profile. The database containing the WAN user profile is generally referred to as Home Location Register (HLR) 36 and the users associated with HLR 36 are generally referred to as the home customers or users. It is appreciated that HLR 36 for home customers can be integrated into the MSC 30 or stored on a separate platform.

MSC 30 sends the data message or registration to HLR 36 over SS7 network 34, notifying HLR 36 that a WAN user or subscriber has requested service from MSC 30. Upon receipt of the registration message from mobile switching center 30, HLR 36 checks the MIN and the ESN contained in the registration message. If the MIN and ESN are determined to be valid, HLR 36 stores the location of cell phone 18 associated with the WAN user and transmits a return message containing the WAN user's profile to MSC 30. The user profile includes information about the user's services (e.g., subscription plan) and features, such as call forwarding, call waiting, 3-way calling, etc.

Upon receipt of the return message from HLR 36, MSC 30 generates a record in its Visitor Location Register (VLR)(not shown) to store the WAN user's profile. MSC 30 refers to the visitor location register associated with the WAN user as the WAN user makes and/or receives calls on the MSC 30. As the WAN user roams from one cell site to another, cell phone 18 associated with the WAN user deregisters with MSC 30 of the previous cell site and registers with new MSC 30 associated with the new cell site. When HLR 36 receives a notification that the WAN user has moved to a different MSC 30 (i.e., different cell site), HLR 36 sends a message to previously registered MSC 30 to cancel or remove the WAN user's profile from the VLR.

Call delivery occurs when someone places a call to cell phone 18. For example, as shown in FIG. 4, when someone dials the phone number of cell phone 18 from a wired telephone 44 connected to a local exchange switch 48, the call is routed to the WAN user's home MSC 40 over PSTN 32. WAN user's home MSC 40 transmits a query to HLR 36 over SS7 network 34 to determine the current location of cell phone 18. HLR 36 can search its record to determine the current location of cell phone 18. As noted herein, HLR 36 stores the location of cell phone 18 each time cell phone registers with a particular MSC and provides serving MSC 42 with WAN user's profile. HLR transmits a data message over SS7 network 34 to serving MSC 42 requesting a temporary number for routing the call to cell phone 18 registered with MSC 42.

Serving MSC 42 associates a Temporary Local Directory Number (TLDN) with the WAN user and transmits the TLDN to HLR 36 over SS7 network 34. It is appreciated that the TLDN is a regular telephone number that is routable through the PSTN 32. For example, if the WAN user is roaming in New York City, the TLDN is a temporary New York City number. HLR 36 forwards the received TLDN to home mobile switching center 40, which routes the call to serving mobile switching center's TLDN over PSTN 32.

When serving mobile switching center 42 receives a call directed to the TLDN associated with the WAN user, serving mobile switching center 42 delivers the call to cell phone 18 via cell site 14.

In addition to the normal cellular communication, cell phone 18 can communicate over WLAN-based network 20, such as the Internet, via WLAN access points 24 employing the IEEE 802.11 standard. Cell phone 18 can access, browse or download files from the Internet or transmit/receive email messages over WLAN-based network 20. It is appreciated that WLAN-based network 20 supports higher transmission rates than WAN-based network. The IEEE 802.11b WLAN-based network can support transmission rate of 11 Mbps and IEEE 802.11a WLAN-based network can support transmission rate of 54 Mbps. Whereas, typical WAN-based network can support transmission rates of only 20-50 Kbps. Accordingly, the present invention enables the WAN users to use their WLAN-enabled mobile appliances to obtain the desired WLAN bandwidth on demand from nearby WLAN access point 24, thereby enabling the WAN users to utilize the higher transmission rates of WLAN-based network 20 to surf the Internet, download video and large data files, etc. It is appreciated that the WAN network provider can use the method and system described in co-pending application entitled “Method and System of Informing WAN User of Nearby WLAN Access Points”, Ser. No. ______ [attorney docket number 100111008-1], to determine if the WAN user is within communication range of one or more WLAN access points 24.

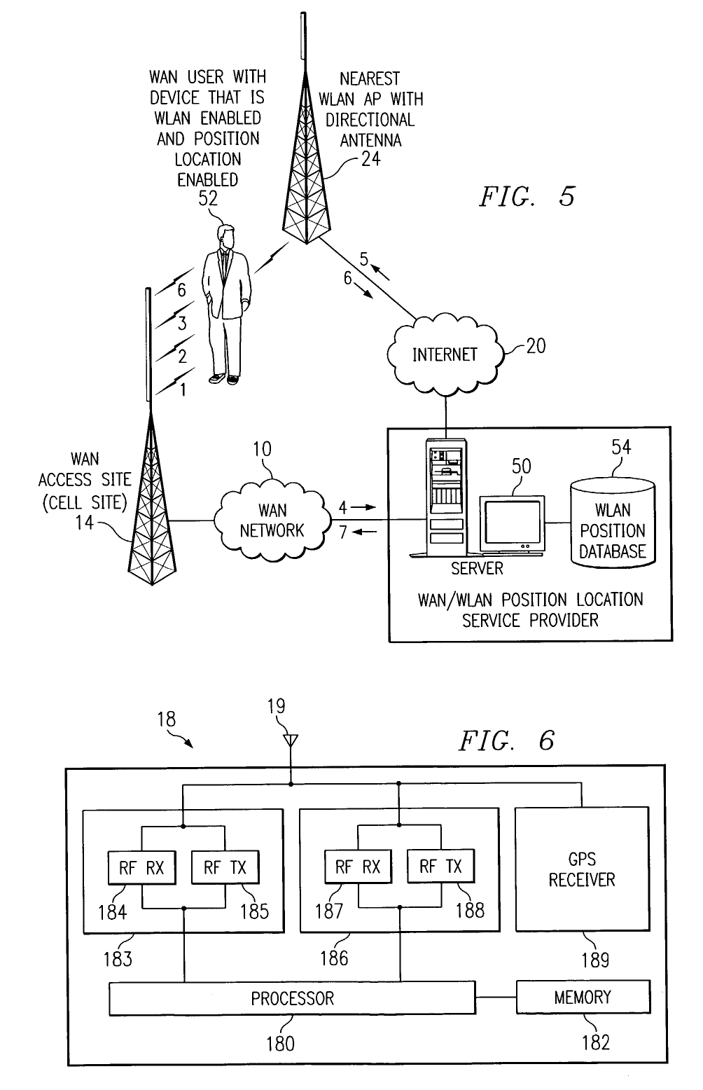

In accordance with an embodiment of the present invention, an example of a method of providing WLAN bandwidth on demand to the WAN user from WLAN access point or site (WLAN-AP) 24 is described in conjunction with FIG. 5. In step 1, WAN user 52 receives a message from the WAN network provider or MSC 30 (FIG. 3) that there is an email with attachment. In step 2, the network provider offers WAN user 52 the option of purchasing sufficient WLAN bandwidth from nearby WLAN access point 24 to perform a task, such as downloading e-mail attachment, sending email with attachment, sending video email, browsing the Internet, downloading web page or file from a web site and the like, using high speed WLAN network 20, such as the Internet 20. In accordance with an aspect of the present invention, the network provider offers WLAN bandwidth on demand to WAN user 52 so that WAN user 52 can perform various tasks as noted herein. The network provider determines the current position of WAN user 52 and selects one or more nearby WLAN access points 24 based on the WAN user's current position. Preferably, the network provider selects WLAN access point 24 that is nearest to WAN user 52 (referred to herein as the serving WLAN access point or cell site) and transmits the attachment to WLAN-enabled mobile appliance 18, such as a cell phone, an e-mail device, a PDA and the like, associated with WAN user 52 from serving WLAN access point 24 via its directional antenna 26. It is appreciated that the network provider can use various known methods and systems to determine the current position of WAN user, such as, but not limited to, the Global Positioning System (GPS), the registration of WAN user 52 with a particular cell site 14 on WAN network 10, automatic location identification associated with enhanced 911 (E911) service advanced by the Federal Communications Commission (FCC), etc.

In accordance with an embodiment of the present invention, steps 1 and 2 can alternatively involve WAN user 52 requesting the WLAN bandwidth on demand service from its WAN network provider to send an e-mail with an attachment, send video email, browse the Internet, download web page or file from a website, etc.

If WAN user 52 elects to utilize the WLAN bandwidth on demand service, then the network provider receives an offer acceptance message from WAN user 52 and determines the current position of WAN user 52 in step 3. Alternatively, WAN user 52 can subscribe to this service in advance so that the network provider can determine the serving WLAN access point 24 and transmit the attachment to WAN user 52 if WAN user 52 has an email attachment and WLAN-enabled mobile appliance 18 associated WAN user 52 is within communication range of one of WLAN access points 24 of WLAN network 20.

The network provider transmits the position information of WAN user 52 and the email attachment to WAN/WLAN position location server 50 over WAN network 10 in step 4. WAN/WLAN position location server 50 searches WLAN position database 54 for WLAN access points 24 that can service WAN user 52 in his/her current position in step 5. Although only one WAN/WLAN position location server 50 and only one WLAN position database 54 are shown connected to WAN network 10, several WAN/WLAN position location servers 50 and WLAN position databases 54 can be coupled to WAN network 10 to provide, for example, robustness and redundancy.

Preferably, WAN/WLAN position location server 50 selects WLAN access point 24 that is nearest to WAN user 52 as serving WLAN access point 24 and determines the directions (e.g., south, northeast, etc.) to the WAN user's current position from serving WLAN access point 24, i.e., the pointing instructions for directional antenna 26 of serving WLAN access point 24 in step 5. Additionally, WAN/WLAN position location server 50 transmits the email attachment to serving WLAN access point 24 and the pointing instructions over WLAN network 20, such as the Internet, in step 5. Alternatively, the network provider can directly access WLAN position database 54 to retrieve the WLAN-AP location/direction information over WAN network 10 and transmits the email attachment along with the pointing instructions to WLAN access point 24 that is nearest to WAN user 52 over WLAN network 20 and a gateway or router (not shown) connecting WAN network 10 and WLAN network 20. Preferably, the retrieved WLAN access points 24 are ordered or prioritized based on their proximity to the WAN user's current position, so that the network provider can select alternate WLAN access point 24 if WLAN access point 24 selected as the serving WLAN access point is out of service or unavailable.

Serving WLAN access point 24 controls its directional antenna 26 based on the received pointing instructions and transmits the email attachment to WLAN-enabled mobile appliance 18 associated with WAN user 52 to deliver the email attachment over high speed WLAN network 20 in step 6. Also, WLAN-enabled mobile appliance 18 associated with WAN user 52 transmits a confirmation message to WAN/WLAN position location server 50 via serving WLAN access point 24 to acknowledge receipt of the email attachment in step 6. If the confirmation message is not received by WAN/WLAN position location server 50 with a predetermined time, such as 30 seconds, 5 minutes, etc., or an error message is received from WLAN-enabled mobile appliance 18, then WAN/WLAN position location server 50 instructs serving WLAN access point to retransmit the email attachment to WAN user 52. In accordance with an embodiment of the present invention, WAN/WLAN position location server 50 can vary the pre-determined time based on the size or bandwidth requirements of the e-mail attachment. Alternatively, WAN/WLAN position location server 50 can select alternate WLAN access point 24 as the new serving WLAN access point 24 to deliver the email attachment. That is, if a confirmation message is not received within the pre-determined time, WAN/WLAN position location server 50 selects new serving WLAN access point 24 and transmits the email attachment and the pointing instructions to new serving WLAN access point 24 over WLAN network 20.

WAN/WLAN position location server 50 forwards the received confirmation message to the network operator over WAN network 10 in step 7 and the network operator charges or bills the WAN user account for the use of this service upon receipt of the confirmation message in step 8. The network operator can bill WAN user 52 based on WLAN bandwidth usage or a predetermined amount for each time the service is used.

It is appreciated that a single WLAN/WAN/Position Location-enabled mobile appliance 18 can be employed to communicate with WLAN access points 24 in communication with WLAN network 20 employing the IEEE 802.11 standard and cell sites 14 in communication with WAN network 10. Turning now to FIG. 6, a schematic representation of WLAN/WAN/Position Location-enabled mobile appliance 18 is shown according to one particular aspect of the present invention, wherein a processor 180 is operable to control the general operation of WLAN-enabled mobile appliance 18. The processor 180 is programmable to control and operate the various components within WLAN enabled mobile appliance 18 in order to carry out the various functions described herein and other components (not shown) typically associated with mobile appliance 18, such as a cell phone, a pager, an email device, a PDA and the like. It is appreciated that the processor or CPU 180 can be any known, available processor, microprocessor, micro-controller or other comparable device. The manner in which processor 180 can be programmed to carry out the functions relating to the present invention will be readily apparent to those having ordinary skill in the art.

WLAN/WAN/Position Location-enabled mobile appliance includes memory 182 which is connected to processor 180. Memory 182 stores the program code executed by processor 180 for carrying out operating functions of WLAN/WAN/Position Location-enabled mobile appliance 18 as described herein. In accordance with an embodiment of the present invention, WLAN/WAN/Position Location-enabled mobile appliance 18 comprises a first Radio Frequency (RF) module 183 connected to processor 180 for transmitting and receiving data from WLAN access points 24 in communication with WLAN network employing the IEEE 802.11 standard. RF module 183 includes RF receiver 184 and RF transmitter 185. RF receiver 184 is operable to receive RF transmissions from WLAN access points 24 connected to WLAN network 20 via antenna 19 and demodulates the received signal to obtain digital information modulated therein. It is appreciated that the antenna 19 may be comprised of multiple antennas tuned for the respective operating frequencies. RF transmitter 185 is operable to transmit information to WLAN access points 24 connected to WLAN network 20, for example, in response to an operator input at keypad (not shown). WLAN/WAN/Position Location-enabled mobile appliance 18 also comprises a second RF module 186 connected to processor 180 for transmitting and receiving data from cell sites 14 connected to WAN network 10. RF module 186 includes RF receiver 187 and RF transmitter 188. RF receiver 187 is operable to receive RF transmissions from cell sites 14 connected to WAN network 10 via antenna 19 and demodulates the signal to obtain digital information modulated therein. RF transmitter 188 is operable to transmit information to cell sites 14 connected to WAN network 10, for example, in response to an operator input at keypad (not shown) or the receipt of a registration request when WLAN/WAN/Position Location-enabled mobile appliance 18 is turned on.

In accordance with an embodiment of the present invention, WLAN/WAN/Position Location-enabled mobile appliance 18 comprises one RF module 183 to transmit and receive data from both cell sites 14 connected to WLAN network 10 and WLAN access points 24 connected to WLAN network 20. It is appreciated that RF module 183 may include additional circuitry or software to operate RF receiver 184 and RF transmitter 185 in dual-mode, i.e., WAN mode and WLAN mode.

In accordance with an embodiment of the present invention, WLAN/WAN/Position Location-enabled mobile appliance 18 comprises a position location device such as the GPS receiver 189 that is in communication via antenna 19 with a worldwide Middle Earth Orbit (MEO) satellite navigational system, i.e., a GPS system, to determine the current position of WLAN/WAN/Position Location-enabled mobile appliance 18. Preferably, upon request, WLAN/WAN/Position Location-enabled mobile appliance 18 transmits its current position information to the network provider. It is appreciated that the antenna 19 may be comprised of multiple antennas tuned for the respective operating frequencies. It will be understood that references to a directional antenna include antennas that can be steered or pointed both mechanically or electronically.

What is claimed is:

1. A method of providing bandwidth on demand to a Wide Area Network (WAN) user from a Wireless Local Area Network (WLAN) access point, comprising:
determining a current position of a mobile appliance associated with said WAN user;
transmitting the current position of said mobile appliance to a position location server over a WAN network;
selecting a WLAN access point from a plurality of WLAN access points that is accessible from the current position of said mobile appliance to provide a serving access point by said position location server;
determining the direction to said mobile appliance from said serving access point to provide directional information;
transmitting said directional information to said serving access point;
controlling a directional antenna of said serving access point in accordance with said directional information such that said directional antenna points in the direction of said mobile appliance;
establishing a communication link between said serving access point and said mobile appliance to provide bandwidth on a WLAN network to said WAN user, thereby enabling said WAN user to access and utilize a WLAN network for performing a task.

2. The method of claim 1 further comprising:
transmitting a request for bandwidth on WLAN network to a mobile switching center from said mobile appliance, wherein the step of determining determines the current position of said mobile appliance after receiving said request for bandwidth on said WLAN network from said WAN user.

3. The method of claim 2 wherein said task includes at least one of the following: downloading an email attachment, sending an email with attachment, browsing the Internet, downloading a web page or file from a web site and sending video email.

4. The method of claim 1 further comprising:
billing a user account associated with said WAN user either based on bandwidth used by said WAN user in performing said task or when said communication link is established to provide the bandwidth to said WAN user.

5. The method of claim 1 further comprising:
transmitting a message with an offer to provide bandwidth on said WLAN network from said serving access point to said mobile appliance over said WAN network if there is an email with attachment for said WAN user, thereby enabling said WAN user to perform the task of downloading the attachment over said WLAN network;
wherein the step of determining determines the current position of said mobile appliance after receiving an offer acceptance message from said mobile appliance over said WAN network;
wherein the step of transmitting transmits said directional information and the attachment to said serving access point; and
wherein the step of establishing said communication link to provide the bandwidth on said WLAN network to enable said WAN user to download the attachment from said serving access point.

6. The method of claim 5 further comprising:
receiving a confirmation message from said mobile appliance acknowledging the receipt of the attachment over said WAN network; and
billing a user account associated with said WAN user for providing the bandwidth on WLAN network when said confirmation message is received by said mobile switching center.

7. The method of claim 6 further comprising:
selecting another WLAN access point from said plurality of WLAN access points as a serving access point if said confirmation message is not received within the predetermined time or an error message is received by said mobile switching center.

8. The method of claim 1 wherein the step of selecting includes:
searching a database for said serving access point based on the current position of said mobile appliance.

9. The method of claim 1 wherein the step of determining the current position determines the current position of said mobile appliance either using a global position system or based on a registration of said mobile appliance to a mobile switching center.

10. A system for providing bandwidth on demand to a Wide Area Network (WAN) user from a Wireless Local Area Network (WLAN) access point, comprising:
a WAN network having a plurality of cell sites;
a WLAN network having a plurality of WLAN access points, wherein each WLAN access point includes at least one directional antenna;
a Mobile Switching Center (MSC), connected to said WAN network, for determining a current position of said mobile appliance;
a mobile appliance associated with said WAN user and in communication with a serving cell site and said MSC, said serving cell site being one of said plurality of cell sites;
at least one position location server, connected to said WAN network and said WLAN network, for receiving the current position of said mobile appliance from said MSC over said WAN network, and selecting a WLAN access point from said plurality of WLAN access points that is accessible from and nearest to the current position of said mobile appliance to provide a serving WLAN access point; and
wherein said serving WLAN access point is operable to establish a communication link with said mobile appliance and to provide a bandwidth on said WLAN network to said WAN user, thereby enabling said WAN user to access and utilize said WLAN network for performing a task.

11. The system of claim 10 wherein said position location server is operable to determine the direction to said mobile appliance from said serving WLAN access point to provide a directional information and to transmit said directional information to said serving WLAN access point; and wherein said serving WLAN access point is operable to control said directional antenna in accordance with said directional information such that said directional antenna points in the direction of said mobile appliance.

12. The system of claim 10 wherein said mobile appliance is operable to transmit a request for bandwidth on said WLAN network to said serving cell site; and wherein said serving cell site is operable to transmit said request to said MSC over said WAN network, thereby enabling said WAN user to obtain bandwidth on said WLAN network to perform said task.

13. The system of claim 10 wherein said task includes at least one of the following: downloading an email attachment, sending an email with attachment, browsing the Internet, downloading a web page or file from a web site and sending video email.

14. The system of claim 10 wherein said MSC is operable to bill a user account associated with said WAN user either based on the bandwidth usage in performing said task by said WAN user or when said serving WLAN access point establishes said communication link with said mobile appliance to provide the bandwidth on said WLAN network to said WAN user.

15. The system of claim 10 wherein said MSC is operable to transmit a message with an offer to provide bandwidth on said WLAN network to said mobile appliance via said WAN network and said serving cell site if there is an email with attachment for said WAN user, to receive an offer acceptance message from said mobile appliance via said serving cell site and said WAN network, and to transmit said directional information and the attachment to said serving WLAN access point upon receipt of said offer acceptance message; and wherein said serving WLAN access point is operable to transmit the attachment to said mobile appliance over said communication link.

16. The system of claim 15 wherein said MSC is operable to receive a confirmation message from said mobile appliance acknowledging the receipt of the attachment via said serving access point and said WAN network, to bill a user account associated with said WAN user for establishing said communication link between said serving access point and said mobile appliance to provide the bandwidth on said WLAN network to said WAN user when said confirmation message is received by said MSC.

17. The system of claim 16 wherein said MSC selects another WLAN access point from said plurality of WAN access points as a serving access point if said confirmation message is not received within the pre-determined time or an error message is received by said MSC.

18. The system of claim 10 further comprising a WLAN position database connected to said position location server; and wherein said position location server is operable to search said WLAN position database to select said serving access point based on the current position of said mobile appliance.

19. The system of claim 10 wherein said MSC is operable to determine the current position of said mobile appliance either using a global position system or based on a registration process of said mobile appliance.

20. The system of claim 10 wherein said mobile appliance is web enabled and includes a position location capability such as a GPS receiver and being one of the following: a cell phone, an email device, a Personal Digital Assistant (PDA), a data terminal or a pager.
